(19) United States
(12) Patent Application Publication
(10) Pub. No.: US 2007/0044043 A1
(43) Pub. Date: Feb. 22, 2007

(54) DBR film for laser imaging

(76) Inventors: David M. Schut, Philomath, OR (US); Andreas Stonas, Corvallis, OR (US); Robert W. Bass, Scio, OR (US); Timothy L. Weber, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/209,274

(22) Filed: Aug. 22, 2005

(51) Int. Cl. G06F 17/50

(52) U.S. Cl. 716/1

(57) ABSTRACT

A system for imaging a substrate can comprise an image data source, an electromagnetic radiation source operatively connected to the image data source and configured to emit electromagnetic radiation in accordance with information provided by the image data source, and a DBR film applied to a substrate. The DBR film can comprise two types of film layers, wherein the two types of film layers are each stable at ambient temperature, each of the two types of film layers having a glass transition temperature (T_{G}) that is lower than the temperature needed to produce deformation of bulk material of the two types of film layers upon interaction with the electromagnetic radiation.

### FIELD OF THE INVENTION

The present invention relates generally to printing images using laser energy. More particularly, the present invention relates to systems and methods for forming images using DBR (diffractive Bragg reflective gradient) film and laser energy.

### BACKGROUND OF THE INVENTION

Compositions which produce a color or other visually perceptible change upon exposure to energy in the form of light or heat are of great interest in producing images on a variety of substrates. Optical disks represent a significant percentage of the market for data storage of software as well as of photographic, video, and/or audio data. Typically, optical disks have data patterns embedded thereon that can be read from and/or written to one side of the disk, and a graphic display or label printed on the other side of the disk.

In order to identify the contents of the optical disk, printed patterns or graphic display information can be provided on the non-data, or label, side of the disk. The patterns or graphic display can be both decorative and provide pertinent information about the data content of the disk. In the past, commercial labeling has been routinely accomplished using screen-printing methods. While this method can provide a wide variety of label content, it tends to be cost ineffective for production of less than about 400 customized disks because of the fixed costs associated with preparing a stencil or combination of stencils and printing the desired pattern or graphic display.

In recent years, the significant increase in the use of optical disks for data storage by consumers has increased the demand to provide customized labels to reflect the content of the optical disk. Most consumer available methods of labeling are limited to either handwritten descriptions which lack professional appearance, quality and variety, or preprinted labels which may be affixed to the disk, but which can also adversely affect the disk performance upon spinning at high speeds.

Recently, color forming compositions have been prepared which include leuco dyes and other additives which have been coated on optical disks. These coatings can be “printed” to in the form of a label using laser energy as is available in many CD and DVD computer drives. Such a product has been developed and marked by Hewlett-Packard Company under the trade name LIGHTSCRIBE. However, though LIGHTSCRIBE technology is effective in providing consumer level printing of labeled optical disks, there is still interest in exploring other methods of marking using laser energy.

### SUMMARY OF THE INVENTION

It has been recognized that it would be advantageous to provide rapidly developable images on various substrates. In one aspect of the present invention, a system for imaging a substrate can comprise an image data source, an electromagnetic radiation source operatively connected to the image data source and configured to emit electromagnetic radiation in accordance with information provided by the image data source, and a DBR film applied to a substrate. The DBR film can be comprised of two types of film layers that are each stable at ambient temperature, each of the two types of film layers also having a glass transition temperature (T_{G}) that is lower than the temperature needed to produce deformation of bulk material of the two types of film layers upon interaction with the electromagnetic radiation.

In another embodiment, a method of imaging DBR film can comprise applying electromagnetic energy to the DBR film to form an image. The DBR film can be comprised of two types of film layers that are each stable at ambient temperature, each of the two types of film layers also having a glass transition temperature (T_{G}) that is lower than the temperature needed to produce deformation of bulk material of the two types of film layers upon interaction with the electromagnetic radiation.

In another embodiment, an optical disk having a DBR film applied thereto is also disclosed herein.

Additional aspects and advantages of the invention will be apparent from the detailed description which follows.

### BRIEF DESCRIPTION OF THE DRAWINGS

FIG. 1 is a schematic representation of a cross-sectional view of a substrate coated with DBR film in accordance with embodiments of the present invention;

FIG. 2 is a schematic representation of a cross-sectional view of a substrate coated with DBR film which has been written to in accordance with embodiments of the present invention; and

FIG. 3 is a three-dimensional graph which shows power versus time values of one embodiment where phase mixing can occur.

### DETAILED DESCRIPTION OF THE PREFERRED EMBODIMENT(S)

Reference will now be made to exemplary embodiments and specific language will be used herein to describe the same. It will nevertheless be understood that no limitation of the scope of the invention is thereby intended. Alterations and further modifications of the inventive features described herein and additional applications of the principles of the invention as described herein, which would occur to one skilled in the relevant art and having possession of this disclosure, are to be considered within the scope of the invention. Further, before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular forms “a,” “an,” and “the” include plural referents unless the context clearly dictates otherwise. Thus, for example, reference to “a radiation absorber” includes reference to one or more of such materials.

As used herein, “developing,” “development,” or the like refers to a change in DBR film after interaction with laser or other similar energy this is typically visibly apparent, e.g., change in reflectance properties, etc.

As used herein, “optical disk” is meant to encompass audio, video, multi-media, and/or software disks that are machine readable in a CD and/or DVD drive, or the like. Examples of optical disk formats include writeable, recordable, and rewriteable disks such as DVD, DVD-R, DVD-RW, DVD+R, DVD+RW, DVD-RAM, CD, CD-ROM, CD-R, CD-RW, and the like. Other like formats may also be included, such as similar formats and formats to be developed in the future.

As used herein, “image,” “imaging,” “graphic display,” etc., refers to any visible character or image found on an optical disk. Typically, images or graphic displays found prominently on one side of the optical disk, though this is not always the case.

As used herein, “data” is typically used with respect to the present disclosure to include the non-graphic information contained on the optical disk that is digitally or otherwise embedded therein. Data can include audio information, video information, photographic information, software information, and the like. Alternatively, the term “data” is sometimes used to describe the information a computer or other processor uses to draw from in order to mark an image on a color-forming composition in accordance with embodiments of the present invention.

Concentrations, amounts, and other numerical information may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a size range of about 1 μm to about 200 μm should be interpreted to include not only the explicitly recited limits of 1 μm to about 200 μm, but also to include individual sizes such as 2 μm, 3 μm, 4 μm, and sub-ranges such as 10 μm to 50 μm, 20 μm to 100 μm, etc.

In accordance with the present invention, a system for imaging a substrate can comprise an image data source, an electromagnetic radiation source operatively connected to the image data source and configured to emit electromagnetic radiation in accordance with information provided by the image data source, and a DBR film applied to a substrate. The DBR film can be comprised of two types of film layers that are each stable at ambient temperature, each of the two types of film layers also having a glass transition temperature (T_{G}) that is lower than that required to produce deformation of bulk material of each of the two types of film layers upon interaction with the electromagnetic radiation.

In another embodiment, a method of imaging DBR film can comprise applying electromagnetic energy to the DBR film to form an image. The DBR film can be comprised of two types of film layers that are each stable at ambient temperature, each of the two types of film layers also having a glass transition temperature (T_{G}) that is lower than that required to produce deformation of bulk material of each of the two types of film layers upon interaction with the electromagnetic radiation.

In another embodiment, an optical disk having a DBR film applied thereto is also disclosed herein.

In accordance with each of the above embodiments, as mentioned, DBR film can be used for imaging. Essentially, a DBR film is a multi-layered composite film comprising alternating materials having different indices of refraction. DBR films typically have two materials that have different indices of refraction with respect to one another. These materials are alternated in stacks. Usually, the bigger the difference in the indices of refraction for each material, the higher the percentage of reflected light per layer. It should be noted that two materials having a smaller difference in their indices of refraction can be functional as well. However, the stack used to form the DBR film usually comprises more layers in order to reflect higher percentages of light. Further, by choosing the correct thickness of material within a DBR thin film stack, selective wavelengths can be reflected, providing desired colored reflections. Further, laser imaging of the DBR film can be modified, e.g., laser power level, focusing depth, and/or duration of contact with DBR film, from one area to the next to provide multiple “color” printing.

In more detail regarding the imaging of DBR film, as mentioned, laser energy can be used to disrupt the natural reflection properties of DBR film. This can be done by using laser energy to selectively alter the interface(s) between individual layers of the DBR film stack. In other words, by raising the temperature of the DBR film using laser energy at discrete locations to disrupt the interfaces, or even melt the materials at these discrete locations, images can be formed (where typically the imaged area has less reflectance than areas that are not imaged). Without the appropriate thickness of each layer provided by the appropriately spaced interfaces, the DBR film will not reflect light from the laser-modified or melted areas, thereby providing a printed image. In one embodiment, a laser beam can then be used to surpass the glass transition temperate (T_{G}) of the two materials of the DBR film stack, forcing the materials to intermingle before quenching and freezing in this imaged state.

In one embodiment, the selection of materials to use with the DBR film can be based on the following criteria. For example, the polymers selected for use can have a glass transition temperature (T_{G}) within a desired range. For example, for low power applications, the glass transition temperature for one or both materials of the DBR film can be from 100° C. to 400° C. Additionally or alternatively, the two (or more) materials selected for use should have at least some difference in their respective indices of refraction. As mentioned, the larger the difference, the higher the percentage of reflected light per layer of material used. However, as also mentioned, it should be noted that small differences in the index of refraction from one layer to the next can also be used to effectuate noticeable reflection. In these embodiments, more layers of material can be used to increase the reflectance of light.

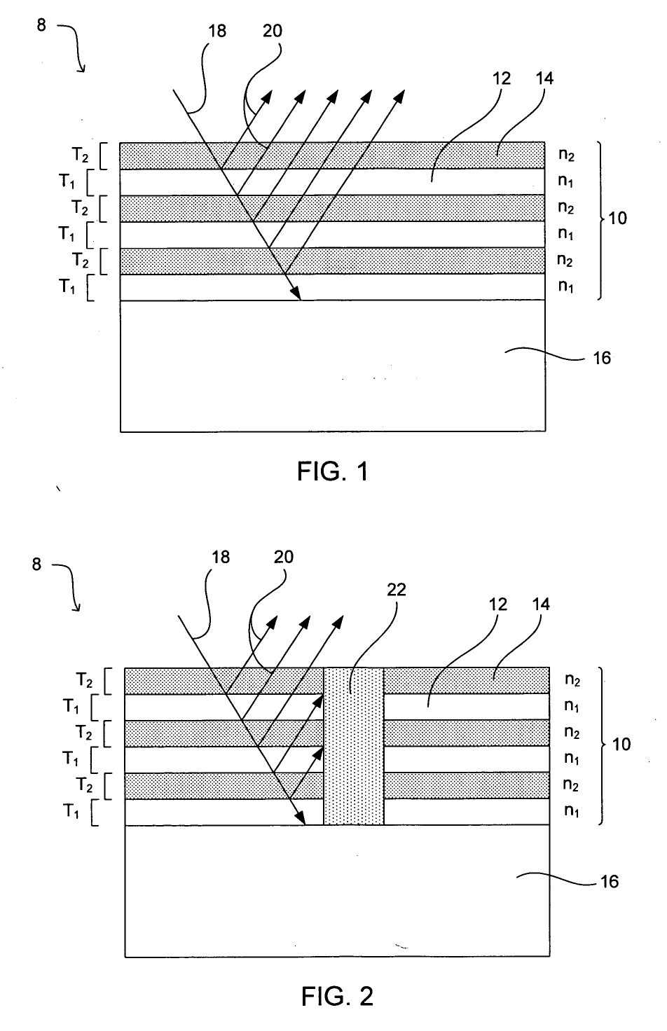

An embodiment of the present invention is shown and described in FIGS. 1 and 2. Specifically, a substrate 16 (such as an optical disk) having a DBR film 10 applied thereto is shown generally at 8. The DBR film includes two types of film layers, a first group of layers 12 having a low index of refraction (n₁) and a second group of layers 14 having a high index of refraction (n₂). The groups of layers are applied in an alternating thin film stack. It is also notable that each of these group of layer types are also associated with a thickness, where the first layer type has a first thickness (t₁) and the second layer type has a second thickness (t₂). The thickness of the layers can be such that they are configured to reflect certain wavelengths of light, as is known in the art. Also shown in FIGS. 1 and 2 is an incident beam of light 18 which is typically representative of ambient light, and a reflected beams of light 20 which reflects from the DBR film, as shown. The reflected light can range from minimal reflectance of certain discrete color(s) to maximum mirror-like reflectance of many to all colors, depending on the characteristics of the DBR film being used.

It should be noted that the terms “high” and “low” when referring to indices of refraction are relative terms indicating that the high index of refraction is merely higher than the index of refraction of the material with the low index of refraction. Further, though the materials are shown in a six-layered stack, it is understood that any number of layers can be used as may be practical and as may be desirable to achieve a desired appearance for a given application. Further, though the first, third, and fifth layers (from the top) are shown as being the material having the high index of refraction, and the second, fourth, and sixth layers are shown as being the material having the low index of refraction, these can be switched. Alternatively, fewer layers of one type of material can be present compared to the other type of material, e.g., 3, 5, 7, etc. alternating layers where there are an even number of one type of layer material and an odd number of the other type of layer material.

In more detail regarding the first group of layers 12 and the second group of layer 14, FIGS. 1 and 2, as well as Equations I and II, demonstrate how the different indices of refraction are used to create a highly reflective bulk film (DBR film). The thickness of the material for incident illumination can be chosen based on the following equations:

$$\begin{matrix}{n}_{1} {t}_{1} = \frac{1}{4} λ & Equation I \\ {n}_{2} {t}_{2} = \frac{1}{4} λ & Equation II\end{matrix}$$

In the above equations, n₁ and n₂, respectively, denote the index of refraction in the two respective material types, and t₁ and t₂ represent the corresponding material thicknesses. One benefit of the arrangement shown (and other similar arrangements) is that multiple stacks with differing bi-layer thicknesses can be fabricated and combined, permitting more wavelengths of light to be reflected. This results in a highly “silvered” film where an appreciable portion of the visible spectrum is reflected.

As exemplified herein, in one embodiment, two types of film layers can be present in alternating layers of a common DBR film. In this embodiment, a first film of the two types of film layers can have an index of refraction from 1.1 to 1.8, and a second film of the two types of film layers can also have an index of refraction from 1.1 to 1.8, provided the index of refraction is different for each of the two types of layers. For example, in one embodiment, the difference between the index of refraction for the first film and the index of refraction for the second film can be at least 0.05.

The application of the layers of material to form the DBR film 8 can be by any of a number of methods known in the art, including spin coating, extrusion, dip coating, etc. As mentioned, after forming the DBR film on a substrate 16, such as an optical disk substrate, a sign substrate, etc., electromagnetic energy (not shown), such as laser energy, can be used to surpass the glass transition temperature (T_{G}) of one, or preferably, both of the materials used to form the first group of layers 12 and the second group of layers 14. In one embodiment, the laser energy can cause the multiple layers to be become intermingled before quenching and freezing in this state, thereby forming a modified portion 22 of the DBR film that is less-reflective than the DBR film in other areas that has not interacted with the laser energy. This mixing of the materials within a given region causes the interfaces between layers to become altered or even removed, thereby modifying the reflectivity at the localized region acted upon by the laser energy. By modifying the reflectivity, imaging can be carried out on the DBR film, as shown by the reflected beams of light 20 failing to reflect as would be expected with other portions of the DBR film. Further, though not shown, reflectance of incident beams of light that are directed toward modified portion would not penetrate the film in the same way as other areas of the DBR film that have not been modified. Thus, due to both effects, contrast is generated between a more reflective or highly reflective portion of the DBR film in non-written areas compared to written area which becomes less reflective. This contrast provides the imaging effect.

It should also be noted that the “silvered” film described above is not the only reflective configuration that can be prepared in accordance with embodiments of the present invention. For example, the stack can also be prepared by selecting appropriate materials and thicknesses to provide a more discrete spectrum of light reflection, i.e. a specific color. Additionally, color may be introduced to DBR film by the writing process by changing the layering thicknesses and/or focusing the laser at different depths, or by exposing various areas for different time periods or at different power levels.

An advantage of using DBR film as a film on certain substrates, such as optical disk substrates, can provide an advantage over leuco dye-based systems previously known. For example, these types of systems can reduce the cost of manufacturing. To illustrate, two polymers that can be obtained very inexpensively include polycarbonate and polystyrene, both of which will work in accordance with the present invention. These polymers have an index of refraction (η_{Δ}) ratio of 1.2. The costs of these materials can be an order of magnitude cheaper than would be required to obtain certain leuco dyes and IR antennas. Further, the systems and methods of the present invention can decrease the power needed to induce to formation of the image compared to traditional leuco dye color-forming compositions. This power decrease has several benefits, including improving the lifetime of the laser (more efficient) as less power is needed to write to DBR film, even using lasers that are typically present in computer optical disk drives. Additionally, as DBR films do not need to be subjected to high power laser energy, minimization of ablation effects can be realized. Ablation can also reduce the laser lifetime as the material may accumulate on the laser optics itself, requiring higher powers to then obtain enough energy to induce the phase transformation. Still further, as less energy is required to write to DBR film using laser energy, the total write time to a DBR film can be reduced compared to other similar label-writing systems. Still further, choice of substrate material is less of an issue with DBR films. More specifically, non-specific substrates may be utilized with DBR films. Even further, DBR films can be applied to virtually any polymeric system which has a relatively sizeable difference in its refractive index and a glass transition temperature (T_{G}) within an appropriate range for the system it will be used with.

A variety of substrates can be used such as polymer, paper, metal, glass, ceramic, and combinations or composites thereof. In one embodiment, the color forming composition can be applied to an optical disk, and thus, select portions thereof can be subsequently developed using a laser or other radiation source. Once the DBR film is applied to the substrate, the conditions under which the DBR film can be modified or imaged can be varied. For example, one can vary the electromagnetic radiation wavelength, heat flux, and exposure time. Variables such as spot size, focusing depth, and laser power will also affect any particular system design and can be chosen based on the desired results. With these variables fixed at predetermined values (or configured to be variable for different. printing effects), the radiation source can then direct electromagnetic radiation to the color forming composition in accordance with data received from a signal processor.

Typically, with optical disk printing, an image to be formed on the surface can be digitally stored and then rasterized or spiralized. The resulting data can be delivered to a radiation source which exposes portions of the DBR film while the optical disk is spinning. DBR films, such as those applied to optical disks, can be developed using lasers having from about 1 mW to about 100 mW power usage, although lasers having a power outside this range can also be used. For example, lower powers levels can be used, but the exposure time increases. Typically, lasers having from about 10 mW to about 50 mW are readily commercially available and work well using the color forming composition described herein. The spot size generated by the laser can be determined by radiation that contacts the substrate at a single point in time. The spot size can be circular, oblong, or other geometric shape, and can range from about 1 μm to about 200 μm along a largest dimension and often from about 5 μm to about 60 μm, though smaller or larger sizes can also be used. In a further aspect, spot sizes of 5 μm to 25 μm×50 μm, as measured across perpendicular major and minor axes, can provide a good balance between resolution and developing speed.

Heat flux is a variable that can be altered as well, and can be from about 0.05 J/cm² to about 5.0 J/cm² in one embodiment, and from about 0.3 J/cm² to about 0.5 J/cm² in a second embodiment. In general, a heat flux of less than about 0.5 J/cm² can also be used. Heat flux in these ranges allow for development of discrete portions of the DBR film for imaging at from about 5 μsec to about 1 millisecond per dot in some embodiments. Those skilled in the art can adjust these and other variables to achieve a variety of resolutions and developing times. It is notable that the above is merely exemplary, as various power and time profiles are specific to the material used and other variables. For example, an aspect of the invention is that an exposure time minimum and an exposure power minimum for each time is used to get a change the reflectivity or contrast of the DBR film. The bit size can change with longer pulses and higher powers. Other variables which will affect the spot size include heat capacity of the polymer layer, thermal conductivity of the polymer layer, and focusing of the electromagnetic radiation source (better focused energy tends to result in higher and faster heat buildup in an area, whereas more poorly focused energy is less likely to lead to a surpassing the T_{G} of the material in a short amount of time)

In embodiments where the substrate is an optical disk or other moving substrate, the exposure time will depend on the rate of motion of the substrate. More specifically, in such embodiments, the exposure times above refer to the time during which a point on the substrate is exposed to the radiation. For example, a spot size of 50 μm along the direction of rotation will result in a single point on the substrate traveling through the spot starting at one edge and traveling to the opposite edge. The total exposure time is therefore the average time that radiation contacts a particular point on the DBR film. When imaging, visible bits are written into the DBR film to help speed up the writing process. When using this technology to write data, more minimally sized bits can be used for higher data density storage capability.

Though any laser can be used to provide energy to DBR films, currently there are many known laser types. Those of particular interest include those commercially available which can be incorporated into an optical disk reading and/or writing device, particularly those in the 200 nm to 1200 nm wavelength range. However, wavelengths outside of this range are also included in accordance with embodiments of the present invention. Exemplary laser types that can be used include krypton-fluoride excimer (249 nm), xenon-chloride eximer (308 nm), nitrogen gas (337 nm), organic dye in solution (300 nm to 1000 nm—tunable), krypton ion (335 nm to 800 nm), argon ion (450 nm to 530 nm), helium neon (543 nm, 632.8 nm, and 1150 nm), semiconductor GaInP family (670 nm to 680 nm), ruby (694 nm), semiconductor GaAlAs family (750 nm to 900 nm), neodymium YAG (1064 nm), semiconductor InGaAsP family (1300 nm to 1600 nm), hydrogen-fluoride chemical (2600 nm to 3000 nm), etc. In addition to the above, these and other commercially available lasers are available having wavelengths of: 375 nm, 405 nm, 408 nm, 440 nm, 635 nm, 638 nm, 650 nm, 660 nm, 670 nm, 685 nm, 780 nm, 785 nm, 810 nm, 830 nm, 850 nm, 980 nm, 1084 nm, 1310 nm, and 1550 nm, for example. These laser-types or others are useable in accordance with embodiments of the present invention, provided the laser energy is functional for imaging DBR films in accordance with embodiments of the present invention.

The following example illustrates an exemplary embodiment of the invention. However, it is to be understood that the following is only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following example provides further detail in connection with what is presently deemed to be practical embodiments of the invention.

### EXAMPLE

A Dichroic Filter Film (PHOTONICS FILTER FILM DFA-42-72 by 3M, St. Paul, Minn.), which is a DBR film as described herein, was used in the present example. According to experimental specifications, this film is flexible, light weight, conforms to simply curved surfaces, reflective, metal-free (non-corroding/non-conductive), thermally stable, etc. The reflective filter band is T<50%, θ_{inc}=0 (420-720 nm (+/−3%)), and the High Extinction Band has an average of T<1%, θ_{inc}=0 (430-695 nm (+/−3%)). The thickness of this film is 51 μm (+/−3%), the density is 1.33 gm/cm³, the break elongation (ASTM D-882) is greater than 75%, the shrinkage after 15 minutes unrestrained at 150° C. in a forced air oven is less than 0.5%. This product is described by 3M as useful for a normal incidence cold mirror, visible reflector, or conformable reflector.

The DBR film described above is attached to a substrate, and tested for laser writing in accordance with embodiments of the present invention. All testing was done on a static X-Y stage tester available from Tui Optics of Germany. A bit (or image) was written on the DBR film, and then the stage was allowed to move in either an X and/or Y translation location. The Z-axis was fixed, but can control focusing capability in the Z-axis direction, e.g., 2 nm steps. The two laser sets that were used were as follows:
Set No. 1: 399 nm write laser, 422 read laser
Set No. 2: 680 nm write laser, 635 read laser

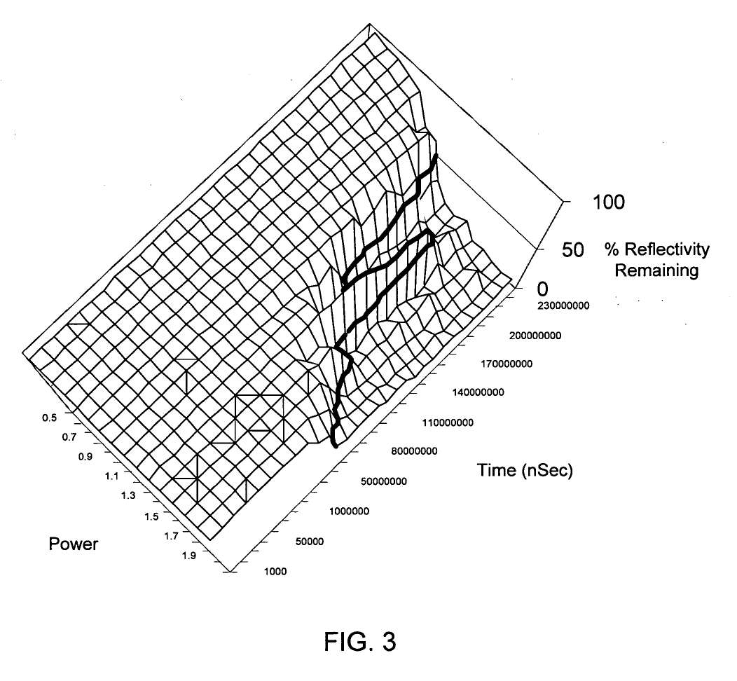

FIG. 3 is a three-dimensional graph which shows power vs. time values where phase mixing occurred. Specifically, in FIG. 3, values above the thickened line indicate combinations of time and power where phase mixing, i.e. writing, occurred, whereas values below the thickened line indicate combinations of time and power where phase mixing did not sufficiently occur to result in image writing. The major concerns in this test were the reading of reflectivity (which are all equal and is the amount of light reflected back after writing to the polymeric film), and the ½ cycle concerned with writing to the material. The test pattern was a linear array of bits in which the power of writing, P(alpha), and the time of writing, T(kappa-alpha), were varied. All else remained constant. It appeared that a desirable T(kappa-alpha) tested was about 30 ms for 399 nm, and a desirable P(alpha) for this time was about 2 mW for 399 nm.

It is to be understood that the above-referenced arrangements are illustrative of the application for the principles of the present invention. Numerous modifications and alternative arrangements can be devised without departing from the spirit and scope of the present invention while the present invention has been described above in connection with the exemplary embodiments(s) of the invention. It will be apparent to those of ordinary skill in the art that numerous modifications can be made without departing from the principles and concepts of the invention as set forth in the claims.

What is claimed is:

1. A system for imaging a substrate, comprising:
a) an image data source;
b) an electromagnetic radiation source operatively connected to the image data source and configured to emit electromagnetic radiation in accordance with information provided by the image data source;
c) a DBR film applied to a substrate, said DBR film comprising two types of film layers, wherein the two types of film layers are each stable at ambient temperature and each of the two types of film layers have a glass transition temperature (T_{G}) that is lower than that required to produce deformation of bulk material of each of the two types of film layers upon interaction with the electromagnetic radiation.

2. A system as in claim 1, wherein the electromagnetic radiation is laser energy.

3. A system as in claim 2, wherein the laser energy has a wavelength from about 200 nm to 1200 nm.

4. A system as in claim 3, wherein the wavelength is about 780 nm.

5. A system as in claim 3, wherein the laser energy is configured to be applied to the DBR film at from about 0.05 J/cm² to about 5 J/cm².

6. A system as in claim 3, wherein the laser energy is configured to be applied to the DBR film at from about 15 μsec to about 500 μsec.

7. A system as in claim 3, wherein the laser energy provides a spot size from about 10 μm to about 60 μm.

8. A system as in claim 3, wherein the laser energy is configured to be applied to the DBR film at a power level from about 1 mW and about 100 mW.

9. A system as in claim 1, wherein the substrate is an optical disk.

10. A system as in claim 1, wherein at least one of the two types of film layers has a glass transition temperature (T_{G}) from about 100° C. to about 400° C.

11. A system as in claim 10, wherein the two types of film layers both have a glass transition temperature (T_{G}) from about 100° C. to about 400° C.

12. A system as in claim 1, wherein the two types of film layers are present in alternating layers, wherein a first film of the two types has an index of refraction from 1.1 to 1.8, and a second film of the two types has an index of refraction from 1.1 to 1.8

13. A system as in claim 12, wherein the difference between the index of refraction of the first film and the index of refraction of the second film is at least 0.05.

14. A system as in claim 1, wherein the DBR film has a first reflective property, and wherein upon application of the electromagnetic energy to a portion of the DBR film, the first reflective property is altered at the portion of the DBR film.

15. A method of imaging DBR film, comprising applying electromagnetic energy to the DBR film to form an image, said DBR film comprising two types of film layers, wherein the two types of film layers are each stable at ambient temperature and each of the two types of film layers have a glass transition temperature (T_{G}) that is lower than that required to produce deformation of bulk material of each of the two types of film layers upon interaction with the electromagnetic radiation.

16. A method as in claim 15, wherein the electromagnetic radiation is laser energy.

17. A method as in claim 16, wherein the laser energy has a wavelength from about 200 nm to 1200 nm.

18. A method as in claim 17, wherein the wavelength is about 780 nm.

19. A method as in claim 17, wherein the laser energy is applied to the DBR film at from about 0.05 J/cm² to about 5 J/cm².

20. A method as in claim 17, wherein the laser energy is applied to the DBR film at from about 15 μsec to about 500 μsec.

21. A method as in claim 17, wherein the laser energy is applied to the DBR film at spot size from about 10 μm to about 60 μm.

22. A method as in claim 15, wherein the laser energy is applied to the DBR film at a power level from about 1 mW and about 100 mW.

23. A method as in claim 15, wherein the DBR film is associated with a substrate.

24. A method as in claim 23, wherein the substrate is an optical disk.

25. A method as in claim 15, wherein at least one of the two types of film layers has a glass transition temperature (T_{G}) from about 100° C. to about 400° C.

26. A method as in claim 25, wherein the two types of film layers both have a glass transition temperature (T_{G}) from about 100° C. to about 400° C.

27. A method as in claim 15, wherein the two types of film layers are present in alternating layers, wherein a first film of the two types has an index of refraction from 1.1 to 1.8, and a second film of the two types has an index of refraction from 1.1 to 1.8.

28. A method as in claim 27, wherein the difference between the index of refraction of the first film and the index of refraction of the second film is at least 0.05.

29. A method as in claim 15, wherein the DBR film has a first reflective property, and wherein upon application of the electromagnetic energy at a portion of the DBR film, the first reflective property is altered at the portion of the DBR film.

30. An optical disk having a DBR film applied thereto.

31. An optical disk as in claim 30, wherein said DBR film comprises two types of film layers, wherein the two types of film layers are each stable at ambient temperature and each of the two types of film layers have a glass transition temperature (T_{G}) that is lower than the temperature needed to produce deformation of bulk material of the two types of film layers upon interaction with laser energy applied at from about 0.05 J/cm² to about 5 J/cm², at a wavelength from about 200 nm to 1200 nm, and at an application time of about 15 μsec to about 500 μsec.

32. An optical disk as in claim 30, wherein at least one of the two types of film layers has a glass transition temperature (T_{G}) from about 100° C. to about 400° C.

33. An optical disk as in claim 30, wherein the two types of film layers both have a glass transition temperature (T_{G}) from about 100° C. to about 400° C.

34. An optical disk as in claim 30, wherein the two types of film layers are present in alternating layers, wherein a first film of the two types has an index of refraction from 1.1 to 1.8, and a second film of the two types has an index of refraction from 1.1 to 1.8.

35. An optical disk as in claim 34, wherein the difference between the index of refraction for the first film and the index of refraction for the second film is at least 0.05.

36. An optical disk as in claim 30, wherein the DBR film has a first reflective property, and wherein upon application of the electromagnetic energy at a discrete location of the DBR film, the first reflective property is altered at the discrete location.
